(19) United States
(12) Patent Application Publication
(10) Pub. No.: US 2022/0209878 A1
(43) Pub. Date: Jun. 30, 2022

(54) METHOD, SYSTEM AND DEVICE FOR PUSHING INFORMATION, AND STORAGE MEDIUM THEREOF

(71) Applicant: Beijing Dajia Internet Information Technology Co., Ltd., Beijing (CN)

(72) Inventors: Gang LI, Beijing (CN); Yong DUAN, Beijing (CN); Qun WANG, Beijing (CN)

(21) Appl. No.: 17/698,275

(22) Filed: Mar. 18, 2022

Related U.S. Application Data
(63) Continuation of application No. PCT/CN2020/100736, filed on Jul. 7, 2020.

(30) Foreign Application Priority Data
Sep. 20, 2019 (CN) 201910893877.0

(51) Int. Cl. H04H 20/61; H04N 21/2187; H04N 21/647; H04N 21/6332

(52) U.S. Cl. CPC H04H 20/61; H04N 21/6332; H04N 21/64746; H04N 21/2187

(57) ABSTRACT

Disclosed are a method, system and device for pushing information, and storage medium thereof. The method includes: receiving an information pushing request transmitted by a service end; then obtaining the online state information of a live broadcast room on the basis of identification information carried in the information pushing request, and according to the online state information, determining a signaling server set; and pushing information content to each signaling server in the signaling server set, and by means of each signaling server, pushing the information content to each client connected to the live broadcast room.

### CROSS-REFERENCE TO RELATED APPLICATIONS

The present disclosure is a continuation application of International Application No. PCT/CN2020/100736, filed on Jul. 7, 2020, which claims priority to the Chinese patent application No. 201910893877.0 filed on Sep. 20, 2019, the entire content of which is incorporated herein by reference.

### FIELD

The present disclosure relates to the field of computer technologies, in particular to a method, system and device for pushing information, and storage medium thereof.

### BACKGROUND

The information service is a service capable of transferring information between Web Real-Time Communication (WebRTC) endpoints, and the information service, as a basic service of a server, has the characteristics of instantaneous high concurrency, message broadcasting, stateful service and the like.

At present, in the related technical solution, information is transmitted in a user dimension, so that the online state of a user needs to be maintained, that is, the online information of the user needs to be updated when the user enters or exits from a live broadcast room, wherein the online information is the information on which server the user is connected to. After the online information of the user is obtained, an information transmitting request can be initiated to the corresponding server through the online information of the user, and the server finds the corresponding user after receiving the information transmitting request, and finally transmits the information to the client.

### SUMMARY

The present disclosure provides a method, system and device for pushing information, and storage medium thereof, to effectively reduce the amount of data and the degree of concurrency that need to be maintained and ensure the stability of the system.

According to a first aspect of the embodiment of the present disclosure, a method for pushing information is provided and includes: receiving an information pushing request transmitted by a service end, wherein the information pushing request carries identification information of a specified live broadcast room; obtaining online state information of the live broadcast room based on the identification information, and determining a signaling server set associated with the live broadcast room based on the online state information; and pushing information content carried in the information pushing request to each signaling server in the signaling server set, and pushing the information content to respective clients connected to the live broadcast room by means of each signaling server.

According to a second aspect of the embodiment of the present disclosure, system for pushing information is provided and includes at least a signaling server, a room online state server and a server for pushing information, wherein the server for pushing information is configured to receive an information pushing request transmitted by a service end, wherein the information pushing request carries identification information of a specified live broadcast room; the room online state server is configured to obtain online state information of the live broadcast room based on the identification information, and determine a signaling server set associated with the live broadcast room based on the online state information; the server for pushing information is further configured to push information content carried in the information pushing request to each signaling server in the signaling server set; and the signaling server is configured to push the received information content to respective clients connected to the live broadcast room.

According to a third aspect of the embodiment of the present disclosure, a device for pushing information is provided and includes: a processor; and a memory, configured to store instructions executable by the processor; wherein the processor is configured to execute the instructions to implement: receiving an information pushing request transmitted by a service end, wherein the information pushing request carries identification information of a specified live broadcast room; obtaining online state information of the live broadcast room based on the identification information, and determining a signaling server set associated with the live broadcast room based on the online state information; and pushing information content carried in the information pushing request to each signaling server in the signaling server set, and pushing the information content to respective clients connected to the live broadcast room by means of each signaling server.

According to a fourth aspect of the embodiment of the present disclosure, a non-transitory computer readable storage medium is provided. When instructions in the storage medium are executed by a processor of a device for pushing information, a device for pushing information executes the method for pushing information of the first aspect.

### BRIEF DESCRIPTION OF THE DRAWINGS

Accompanying drawings here, which are incorporated in and constitute a part of this description, illustrate embodiments consistent with the present disclosure and, together with the description, serve to explain principles of the present disclosure and do not constitute an inappropriate limitation on the present disclosure.

FIG. 1 is a first flowchart of creating an entity of a live broadcast room shown according to an embodiment.

FIG. 2 is a first schematic diagram of an entity of a live broadcast room shown according to an embodiment.

FIG. 3 is a second flowchart of creating an entity of a live broadcast room shown according to an embodiment.

FIG. 4 is a second schematic diagram of an entity of a live broadcast room shown according to an embodiment.

FIG. 5 is a schematic diagram shown according to an embodiment.

FIG. 6 is a schematic diagram of information content of a live broadcast room shown according to an embodiment.

FIG. 7 is a functional structure block diagram of a system for pushing information shown according to an embodiment.

FIG. 8 is a block diagram of physical architecture of a server for pushing information shown according to an embodiment.

### DETAILED DESCRIPTION OF THE EMBODIMENTS

In order to enable those of ordinary in the art to better understand technical solutions of the present disclosure, the technical solutions in embodiments of the present disclosure will be clearly and fully described in combination with the accompanying drawings.

It should be noted that the terms “first”, “second”, and the like in the description, the claims and the above drawings of the present disclosure are used to distinguish similar objects, and are not necessarily used to describe a specific order or precedence order. It should be understood that the data used in such a manner can be interchanged in appropriate cases such that embodiments of the disclosure described here can be implemented in an order other than those illustrated or described here. Implementations described in the following embodiments do not represent all implementations consistent with the present disclosure. Instead, they are only examples of devices and methods consistent with some aspects of the disclosure as detailed in the attached claims.

A live broadcast room refers to a recording site where audio or video is directly transmitted to audiences without being recorded. In some embodiments, in order to facilitate description, a room for watching live broadcast is called the live broadcast room, and clients connected to the live broadcast room are called an anchor client and an audience client for short respectively. After an entity of a live broadcast room is created, a system for pushing information performs an information pushing process based on an information pushing request transmitted by a service end. The system for pushing information includes a signaling server, a room online state server and a server for pushing information. The clients include an anchor client who initially creates the entity of the live broadcast room, and/or an audience client who is subsequently connected to the entity of the live broadcast room, and the service end is one of the clients, or other terminals except the clients. According to the embodiments of the present disclosure, the operation process of the system for pushing information is described in detail by taking the system for pushing information as an entity.

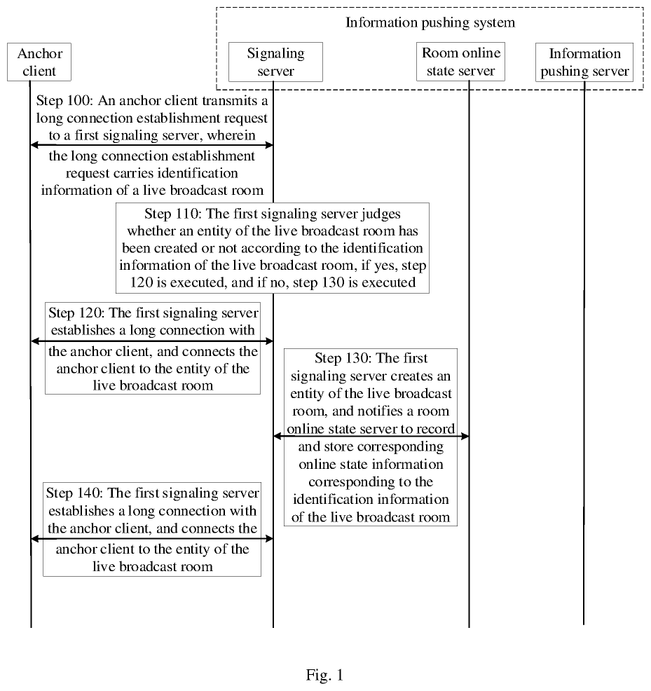

In some embodiments, as long as a certain client, whether an anchor client or an audience client, initially logs in a new signaling server, a creation process will be triggered, so that the method for pushing information provided by the embodiments of the present disclosure may include three parts, namely, a first creation process of an entity of a live broadcast room, a second creation process of the entity of the live broadcast room and a detailed process of information pushing. Referring to FIG. 1, when a certain anchor client makes a request for creating an entity of a live broadcast room to the system for pushing information, the first creation process of the entity of the live broadcast room is as the following Step 100 to Step 140.

Step 100, an anchor client transmits a long connection establishment request to a first signaling server. The long connection establishment request carries identification information of the live broadcast room.

In some embodiments, since the system for pushing information includes a first signaling server, a room online state server and a server for pushing information, when a certain anchor client makes a request for establishing a long connection to the system for pushing information for the first time, the certain anchor client needs to transmit a long connection establishment request carrying the identification information of the live broadcast room to the first signaling server first, so that the interaction of information with the first signaling server through the established long connection in the subsequent process is facilitated.

For example, when the identification information of the live broadcast room is room 1, the anchor client may transmit a long connection establishment request carrying the room 1 to a signaling server 1.

Step 110, the first signaling server judges whether an entity of the live broadcast room has been created according to the identification information of the live broadcast room; if the entity of the live broadcast room has been created, Step 120 is executed, and if the entity of the live broadcast room has not been created, Step 130 is executed.

In some embodiments, after the first signaling server obtains the identification information of the live broadcast room according to the long connection establishment request, the first signaling server needs to judge whether an entity of the live broadcast room has been created on the first signaling server, if the entity of the live broadcast room has been created locally, Step 120 is executed, and if the entity of the live broadcast room has not been created locally, Step 130 is executed.

Step 120, the first signaling server establishes a long connection with the anchor client, and connects the anchor client to the entity of the live broadcast room.

In some embodiments, when the first signaling server determines that an entity of the live broadcast room has been created locally according to identification information of the live broadcast room, the first signaling server establishes a long connection with the anchor client, and connects the anchor client to the entity of the live broadcast room.

Step 130, the first signaling server creates an entity of the live broadcast room, and notifies the room online state server to record and store the corresponding online state information corresponding to the identification information of the live broadcast room.

In some embodiments, when the first signaling server determines that an entity of the live broadcast room has not been created locally according to the identification information of the live broadcast room, the first signaling server creates the entity of the live broadcast room locally, and then notifies the room online state server to store corresponding online state information.

Besides, in the process of creating the entity of the live broadcast room, at least one or any combination of the following information is recorded corresponding to the entity of the live broadcast room: a creation time of an entity of the live broadcast room, anchor information and a title of the live broadcast room.

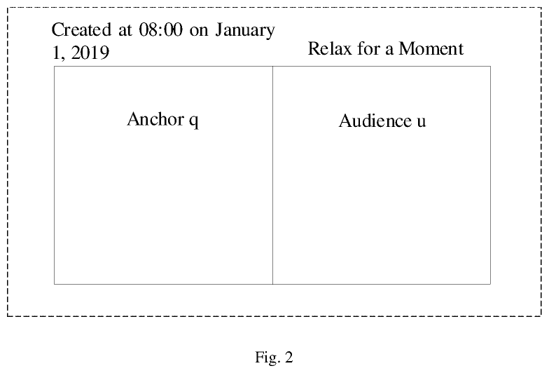

For example, as shown in FIG. 2, when the creation time of the entity of the room 1 is 08:00 on Jan. 1, 2019, the anchor information is anchor q, and the title of the room is Relax for a Moment, the signaling server 1 records the information of the entity of the room 1 as follows: created at 08:00 on Jan. 1, 2019, anchor q, and Relax for a Moment.

Furthermore, after the signaling server 1 creates the entity of the room 1, when the online state information of the room 1 is the room 1 associated with the signaling server 1, the signaling server 1 notifies the room online state server to store “the room 1 associated with the signaling server 1”.

Step 140, the first signaling server establishes a long connection with the anchor client, and connects the anchor client to the entity of the live broadcast room.

In some embodiments, when the first signaling server creates the entity of the live broadcast room, and notifies the room online state server to store corresponding online state information, the first signaling server establishes a long connection with the anchor client and connects the anchor client to the entity of the live broadcast room.

In some embodiments, any one live broadcast room may be connected with 100, 1000 and even tens of thousands of audience clients, and the embodiments of the present disclosure are explained by only taking one audience client as an example.

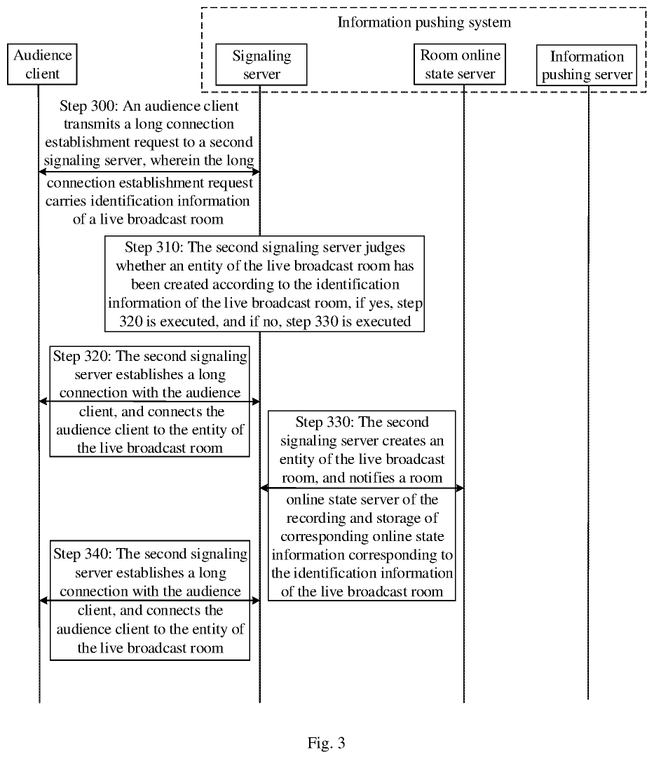

As shown in FIG. 3, when a certain audience client makes a request for creating an entity of a live broadcast room to the system for pushing information, the second creation process of the entity of the live broadcast room is as the following Step 300 to Step 340.

Step 300, the audience client transmits a long connection establishment request to a second signaling server. The long connection establishment request carries identification information of the live broadcast room.

In some embodiments, since the system for pushing information includes a second signaling server, a room online state server and a server for pushing information, when a certain audience client makes a request for establishing a long connection to the system for pushing information for the first time, the audience client needs to transmit a long connection establishment request carrying the identification information of the live broadcast room to the second signaling server first, so that the interaction of information with the second signaling server through the established long connection in the subsequent process is facilitated.

For example, it is assumed that a second signaling server into which an audience client logs is different from a first signaling server into which an anchor client logs, and when the identification information of the live broadcast room is room 1, the audience client may transmit a long connection establishment request carrying the room 1 to a signaling server 2.

Step 310, the second signaling server judges whether an entity of the live broadcast room has been created according to the identification information of the live broadcast room, if the entity of the live broadcast room has been created, Step 320 is executed, and if the entity of the live broadcast room has not been created, Step 330 is executed.

In some embodiments, after the second signaling server obtains the identification information of the live broadcast room according to the long connection establishment request, the second signaling server needs to judge whether an entity of the live broadcast room has been created on the second signaling server, if the entity of the live broadcast room has been created on the second signaling server, Step 320 is executed, and if the entity of the live broadcast room has not been created on the second signaling server, Step 330 is executed.

Step 320, the second signaling server establishes a long connection with the audience client, and connects the audience client to the entity of the live broadcast room.

In some embodiments, when the second signaling server determines that the entity of the live broadcast room has been created locally according to the identification information of the live broadcast room, the second signaling server establishes a long connection with the audience client and connects the audience client to the entity of the live broadcast room.

Step 330, the second signaling server creates an entity of the live broadcast room, and notifies the room online state server to record and store the corresponding online state information corresponding to the identification information of the live broadcast room.

In some embodiments, when the second signaling server determines that an entity of the live broadcast room is not created locally according to the identification information of the live broadcast room, the second signaling server creates the entity of the live broadcast room, and then notifies the room online state server to store corresponding online state information.

Besides, in the process of creating the entity of the live broadcast room, at least one or any combination of the following information is recorded corresponding to the entity of the live broadcast room: a creation time of an entity of the live broadcast room, anchor information and a title of the live broadcast room.

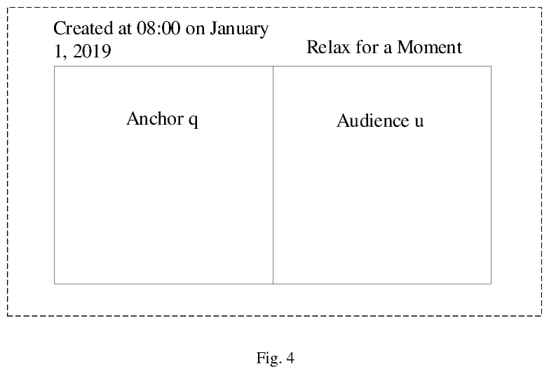

For example, as shown in FIG. 4, when the creation time of the entity of the room 1 is 08:00 on Jan. 1, 2019, the anchor information is anchor q, participant information is audience u, and the title of the room is Relax for a Moment, the signaling server 2 records the information of the entity of the room 1 as follows: created at 08:00 on Jan. 1, 2019, anchor q, audience u and Relax for a Moment.

Furthermore, after the signaling server 2 creates the entity of the room 1, when the online state information of the room 1 is that the room 1 is associated with the signaling server 2, the signaling server 1 notifies the room online state server of the storage of “the room 1 associated with the signaling server 2”.

Besides, in the process that the anchor client transmits the long connection establishment request to the first signaling server, after the signaling server 1 establishes the entity of the room 1, the room online state server records “the room 1 associated with the signaling server 1” according to the notification of the signaling server 1, so that the room 1 is finally associated with two signaling servers, namely, the signaling server 1 and the signaling server 2, and a final result recorded by the room online state server is that “the room 1 is associated with the signaling server 1 and the signaling server 2”.

Step 340, the second signaling server establishes a long connection with the audience client, and connects the audience client to the entity of the live broadcast room.

In some embodiments, when the second signaling server creates an entity of the live broadcast room, and notifies the room online state server to store corresponding online state information, the second signaling server establishes a long connection with the audience client and connects the audience client to the entity of the live broadcast room.

It needs to be noted that in the two embodiments for the entity of the live broadcast room, the description process is explained only by taking the anchor client and one audience client as an example, and in practical application, when audience clients log into different signaling servers, the signaling servers will create the entity of the live broadcast room and notify the room online state server of the recording of the online state information in the same manner.

Thus, after the system for pushing information operates for a period of time, the room online state server records a signaling server set corresponding to the identification information of the live broadcast room, and the signaling servers in the signaling server set are associated with the live broadcast room. Moreover, in the subsequent information pushing process, the server for pushing information will push the information content to each signaling server in the signaling server set, and the information content is transmitted to each client by means of each signaling server.

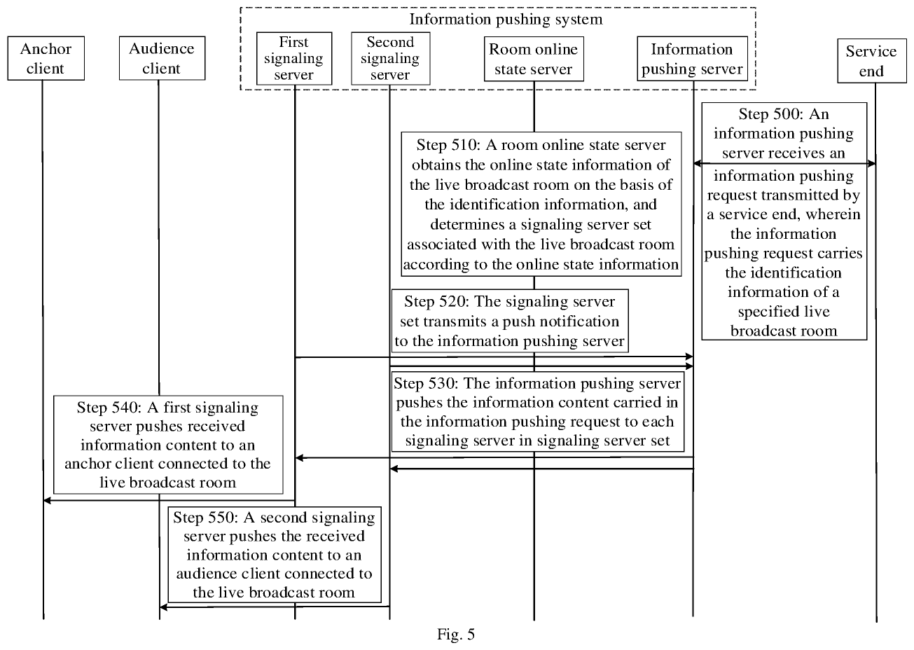

In some embodiments, referring to FIG. 5, a certain service end transmits an information pushing request to a system for pushing information, and the detailed process of information pushing is as the following Step 500 to Step 550.

Step 500, a server for pushing information receives an information pushing request transmitted by a service end. The information pushing request carries the identification information of a specified live broadcast room.

In some embodiments, after a signaling server creates an entity of a live broadcast room for each of the clients, a service end may transmit an information pushing request carrying identification information of the live broadcast room to a server for pushing information. Since the service end is one of the clients or other terminals except the clients, and the clients include an anchor client and an audience client, description will be made below by only one other terminal as an example.

For example, a server for pushing information receives an information pushing request transmitted by the other terminal, and identification information of a specified live broadcast room carried in the information pushing request is room 1.

Step 510, a room online state server obtains online state information of the live broadcast room based on the identification information, and determines a signaling server set associated with the live broadcast room according to the online state information.

For example, when online state information obtained by the room online state server based on room 1 is that “the room 1 is associated with a signaling server 1 and a signaling server 2”, it is determined that a signaling server set associated with the room 1={the signaling server 1, the signaling server 2}.

Step 520, the signaling server set transmits a push notification to the server for pushing information.

For example, when the signaling server set={the signaling server 1, the signaling server 2}, the signaling server 1 and the signaling server 2 transmit a push notification to the server for pushing information, and the server for pushing information is triggered to push the information content to the signaling server 1 and the signaling server 2.

Step 530, the server for pushing information pushes the information content carried in the information pushing request to each signaling server in the signaling server set.

For example, after the server for pushing information receives the push notification transmitted by the signaling server 1 and the signaling server 2, the server for pushing information pushes the information content of “let's act together” carried in the information pushing request to the signaling server 1 and the signaling server 2.

Step 540, a first signaling server pushes the received information content to an anchor client connected to the live broadcast room.

For example, after a signaling server receives the information content of “let's act together” transmitted by the server for pushing information, “let's act together” is pushed to each client connected to the room 1, that is, the signaling server 1 pushes “let's act together” to an anchor client connected to the room 1.

Step 550, a second signaling server pushes the received information content to an audience client connected to the live broadcast room.

For example, a signaling server 2 pushes “let's act together” to an audience client connected to the room 1.

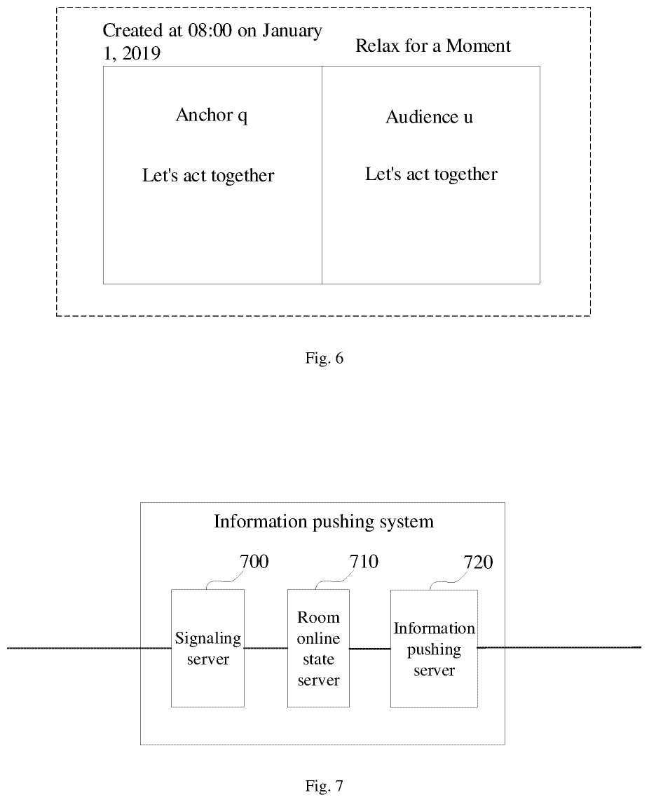

In some embodiments, referring to FIG. 6, after a signaling server 1 and a signaling server 2 respectively push “let's act together” to an anchor client and an audience client which are connected to a room 1, both an anchor q and an audience u in the room 1 may receive the information content of ‘let's act together’.

Therefore, when the service end needs to transmit the information content, after the room online state server determines the signaling server set, the server for pushing information can transmit the information content to each signaling server, and then the signaling server can push the information content to each client connected to the live broadcast room, namely, each client can receive the information content transmitted by the service end. Furthermore, information content does not need to be transmitted according to user dimensions, and the interaction of information of different rooms is directly carried out according to room dimensions, so that the amount of data and the degree of concurrency that need to be maintained are effectively reduced, the problem of ultrahigh traffic concurrency in the information transmitting process is solved, and the stability of the system is ensured.

FIG. 7 is a functional structure block diagram of a system for pushing information shown according to an embodiment. As shown in FIG. 7, the system includes at least a signaling server 700, a room online state server 710 and a server for pushing information 720. The server for pushing information 720 is configured to receive an information pushing request transmitted by a service end, and the information pushing request carries identification information of a specified live broadcast room.

The room online state server 710 is configured to obtain online state information of the live broadcast room based on the identification information, and determine a signaling server set associated with the live broadcast room according to the online state information.

The server for pushing information 720 is further configured to push information content carried in the information pushing request to each signaling server in the signaling server set.

The signaling server 700 is configured to push the received information content to respective clients connected to the live broadcast room.

In some embodiments, before the server for pushing information receives an information pushing request transmitted by a service end, the signaling server 700 is further configured to: receive a long connection establishment request transmitted by at least one client, wherein the long connection establishment request carries the identification information of the live broadcast room; and establish a long connection between the signaling server and the at least one client, and connect the client to an entity of the live broadcast room in response to determining that the entity of the live broadcast room has been created locally according to the identification information of the live broadcast room.

In some embodiments, the signaling server 700 is further configured to: create an entity of the live broadcast room on the signaling server, and notify the room online state server of the recording and storage of corresponding online state information corresponding to the identification information of the live broadcast room in response to determining that the entity of the live broadcast room is not created on the signaling server, and establish a long connection between the signaling server and the client, and connect the client to the entity of the live broadcast room.

In some embodiments, the signaling server 700 is further configured to: record at least one or any combination of the following information corresponding to the entity of the live broadcast room in the process of creating the entity of the live broadcast room: a creation time of an entity of the live broadcast room, anchor information and a title of the live broadcast room.

In some embodiments, the respective clients include an anchor client which initially creates an entity of the live broadcast room, and/or an audience client which is subsequently connected to the entity of the live broadcast room; and, the service end is one of the clients or other terminals except the clients.

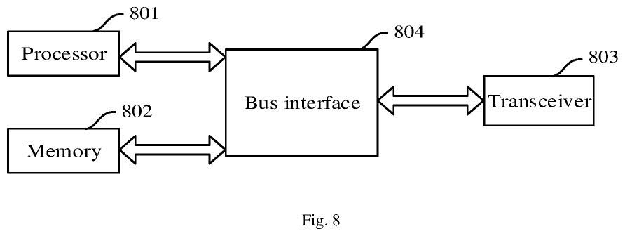

On the other hand, in some embodiments, assuming that the function of the server is powerful enough, then the functions of the server for pushing information, the room online state server and the signaling server in the system for pushing information can be integrated together to be completed, and referring to FIG. 8, based on the same inventive concept, the embodiment of the present disclosure provides a server for pushing information, as shown in the figure, the physical device may include a processor 801, a memory 802, a transceiver 803 and a bus interface 804. The processor 801 is configured to read computer instructions in the memory 802 and execute any of the methods executed by the system for pushing information.

The processor 801 is responsible for managing bus architecture and usual processing, and the memory 802 can store data used by the processor 801 for performing operations. The transceiver 803 is configured to receive and transmit data under the control of the processor 801.

The bus architecture may include any number of interconnected buses and bridges, and specifically links various circuits of one or more processors represented by the processor 801 and memories represented by the memory 802 together. The bus architecture may also link together various other circuits such as peripheral devices, voltage regulators, and power management circuits, which are well known in the art, and therefore will be no longer further described herein. The bus interface provides an interface. The processor 801 is responsible for managing bus architecture and usual processing, and the memory 802 can store data used by the processor 801 for performing operations.

Based on the same inventive concept, the embodiment of the present disclosure provides a non-transitory computer readable storage medium, the storage medium stores computer executable instructions, and the computer executable instructions are used for enabling a computer to execute the method executed by the system for pushing information in the embodiment.

In conclusion, in the embodiment of the present disclosure, firstly, the system for pushing information receives the information pushing request transmitted by the service end, wherein the information pushing request carries identification information of the specified live broadcast room, then, the system for pushing information obtains the online state information of the live broadcast room on the basis of the identification information, and determines the signaling server set associated with the live broadcast room, then pushes the information content carried in the information pushing request to each signaling server in the signaling server set, and pushes the information content to each client connected to the live broadcast room by means of each signaling server. Therefore, the system for pushing information may transmit the information content to each client that establishes a connection with the live broadcast room without maintaining the online state information of each client, and may directly complete the interaction of information according to the online state information of the live broadcast room, thereby solving the problem of ultrahigh traffic concurrency during information transmission, remarkably reducing the amount of data and the degree of concurrency that need to be maintained, improving the stability of the system and reducing the operation and maintenance costs of the system, and further ensuring the smooth transmission of the information content to each client, improving the quality of service of the system, and improving the degree of user experience during information transmission.

Other embodiments of the present disclosure will be readily conceived by those skilled in the art after taking into account the description and practicing the disclosure disclosed herein. The present disclosure is directed to encompassing any variation, use or adaptive variation of the disclosure that follow the general principles of the disclosure and include known common knowledge or habitual technical means in the art that are not disclosed by the disclosure. The description and embodiments are considered only exemplary, and the true scope and spirit of the disclosure are indicated by the following claims.

It should be understood that the present disclosure is not limited to the precise structures that have been described above and shown in the figures, and that various modifications and changes can be made to the present disclosure without departing from the scope of the present disclosure. The scope of the present disclosure is limited only by the attached claims.

What is claimed is:

1. A method for pushing information, comprising:
receiving an information pushing request transmitted by a service end, wherein the information pushing request carries identification information of a specified live broadcast room;
obtaining online state information of the live broadcast room based on the identification information, and determining a signaling server set associated with the live broadcast room based on the online state information; and
pushing information content carried in the information pushing request to each signaling server in the signaling server set, and pushing the information content to respective clients connected to the live broadcast room by means of each signaling server.

2. The method according to claim 1, further comprising:
executing the following operations for each client in the respective clients:
receiving a long connection establishment request transmitted by a client by means of a signaling server, wherein the long connection establishment request carries the identification information of the live broadcast room; and
establishing a long connection between the signaling server and the client, and connecting the client to an entity of the live broadcast room in response to determining that the entity of the live broadcast room has been created on the signaling server based on the identification information of the live broadcast room.

3. The method according to claim 2, further comprising:
creating an entity of the live broadcast room on the signaling server, and recording and storing corresponding online state information corresponding to the identification information of the live broadcast room in response to determining that the entity of the live broadcast room is not created on the signaling server, and
establishing a long connection between the signaling server and the client, and connecting the client to the entity of the live broadcast room.

4. The method according to claim 3, further comprising:
recording at least one or any combination of the following information corresponding to the entity of the live broadcast room in a process of creating the entity of the live broadcast room: a creation time of the entity of the live broadcast room, anchor information and a title of the live broadcast room.

5. The method according to claim 1, wherein
the respective clients comprise an anchor client initially creating an entity of the live broadcast room, and/or an audience client subsequently being connected to an entity of the live broadcast room; and
the service end is one of the respective clients or other terminals except the respective clients.

6. A system for pushing information, comprising at least a signaling server, a room online state server and a server for pushing information, wherein
the server for pushing information is configured to receive an information pushing request transmitted by a service end, wherein the information pushing request carries identification information of a specified live broadcast room;
the room online state server is configured to obtain online state information of the live broadcast room based on the identification information, and determine a signaling server set associated with the live broadcast room based on the online state information;
the server for pushing information is further configured to push information content carried in the information pushing request to each signaling server in the signaling server set; and
the signaling server is configured to push the received information content to respective clients connected to the live broadcast room.

7. The system according to claim 6, wherein before the server for pushing information receives the information pushing request transmitted by the service end, the signaling server is further configured to:
receive a long connection establishment request transmitted by at least one client, wherein the long connection establishment request carries the identification information of the live broadcast room; and
establish a long connection between the signaling server and the at least one client, and connect the client to an entity of the live broadcast room in response to determining that the entity of the live broadcast room has been created locally based on the identification information of the live broadcast room.

8. The system according to claim 7, wherein the signaling server is further configured to:
create an entity of the live broadcast room on the signaling server, and notify the room online state server to record and store corresponding online state information corresponding to the identification information of the live broadcast room in response to determining that the entity of the live broadcast room is not created on the signaling server, and
establish a long connection between the signaling server and the client, and connect the client to the entity of the live broadcast room.

9. The system according to claim 8, wherein the signaling server is further configured to:
record at least one or any combination of the following information corresponding to the entity of the live broadcast room in a process of creating the entity of the live broadcast room: a creation time of the entity of the live broadcast room, anchor information and a title of the live broadcast room.

10. The system according to claim 6, wherein
the respective clients comprise an anchor client initially creating an entity of the live broadcast room, and/or an audience client subsequently being connected to an entity of the live broadcast room; and
the service end is one of the respective clients or other terminals except the respective clients.

11. A device for pushing information, comprising:
a processor; and
a memory, configured to store instructions executable by the processor;
wherein the processor is configured to execute the instructions to implement:
receiving an information pushing request transmitted by a service end, wherein the information pushing request carries identification information of a specified live broadcast room;
obtaining online state information of the live broadcast room based on the identification information, and determining a signaling server set associated with the live broadcast room based on the online state information; and
pushing information content carried in the information pushing request to each signaling server in the signaling server set, and pushing the information content to respective clients connected to the live broadcast room by means of each signaling server.

12. The device for pushing information according to claim 11, wherein the processor is further configured to execute the instructions to implement:
the following operations for each client in the respective clients:
receiving a long connection establishment request transmitted by a client by means of a signaling server, wherein the long connection establishment request carries the identification information of the live broadcast room; and
establishing a long connection between the signaling server and the client, and connecting the client to an entity of the live broadcast room in response to determining that the entity of the live broadcast room has been created on the signaling server based on the identification information of the live broadcast room.

13. The device for pushing information according to claim 12, wherein the processor is further configured to execute the instructions to implement:
creating an entity of the live broadcast room on the signaling server, and recording and storing corresponding online state information corresponding to the identification information of the live broadcast room in response to determining that the entity of the live broadcast room is not created on the signaling server, and
establishing a long connection between the signaling server and the client, and connecting the client to the entity of the live broadcast room.

14. The device for pushing information according to claim 13, wherein the processor is further configured to execute the instructions to implement:
recording at least one or any combination of the following information corresponding to the entity of the live broadcast room in a process of creating the entity of the live broadcast room: a creation time of the entity of the live broadcast room, anchor information and a title of the live broadcast room.

15. The device for pushing information according to claim 11, wherein
the respective clients comprise an anchor client initially creating an entity of the live broadcast room, and/or an audience client subsequently being connected to an entity of the live broadcast room; and
the service end is one of the respective clients or other terminals except the respective clients.

16. A non-transitory computer readable storage medium, wherein when instructions in the storage medium are executed by a processor of a device for pushing information, the device for pushing information executes the method for pushing information according to claim 1.

17. The storage medium according to claim 16, wherein when instructions in the storage medium are executed by the processor of the device for pushing information, the device for pushing information further executes:
executing the following operations for each client in the respective clients:
receiving a long connection establishment request transmitted by a client by means of a signaling server, wherein the long connection establishment request carries the identification information of the live broadcast room; and
establishing a long connection between the signaling server and the client, and connecting the client to an entity of the live broadcast room in response to determining that the entity of the live broadcast room has been created on the signaling server based on the identification information of the live broadcast room.

18. The storage medium according to claim 17, wherein when instructions in the storage medium are executed by the processor of the device for pushing information, the device for pushing information further executes:
creating an entity of the live broadcast room on the signaling server, and recording and storing corresponding online state information corresponding to the identification information of the live broadcast room in response to determining that the entity of the live broadcast room is not created on the signaling server, and
establishing a long connection between the signaling server and the client, and connecting the client to the entity of the live broadcast room.

19. The storage medium according to claim 18, wherein when instructions in the storage medium are executed by the processor of the device for pushing information, the device for pushing information further executes:
recording at least one or any combination of the following information corresponding to the entity of the live broadcast room in a process of creating the entity of the live broadcast room: a creation time of the entity of the live broadcast room, anchor information and a title of the live broadcast room.

20. The storage medium according to claim 16, wherein
the respective clients comprise an anchor client initially creating an entity of the live broadcast room, and/or an audience client subsequently being connected to an entity of the live broadcast room; and
the service end is one of the respective clients or other terminals except the respective clients.
